(19) United States
(12) Patent Application Publication
(10) Pub. No.: US 2012/0106778 A1
(43) Pub. Date: May 3, 2012

(54) SYSTEM AND METHOD FOR MONITORING LOCATION OF PERSONS AND OBJECTS

(75) Inventors: Paul Edward Cuddihy, Ballston Lake, NY (US); Austars Raymond Schnore, JR., Scotia, NY (US); Charles Burton Theurer, Alplaus, NY (US); Joseph James Salvo, Schenectady, NY (US); Li Zhang, Clifton Park, NY (US)

(73) Assignee: GENERAL ELECTRIC COMPANY, SCHENECTADY, NY (US)

(21) Appl. No.: 12/913,931

(22) Filed: Oct. 28, 2010

(51) Int. Cl. G08B 21/00; G06K 9/00

(52) U.S. Cl. 382/100; 340/540

(57) ABSTRACT

A method for detecting changes in locations of persons and objects is disclosed. The method includes projecting a plurality of imaging planes across a specified area near a ground level and at none or least one pre-determined height from the ground level. The method also includes capturing respective imaging lines from the plurality of planes via one or more imaging components, observed when the objects or persons intersect the projected imaging planes. The method further includes recording a standard shape of the respective imaging lines in absence of any person or object within the specified area to establish a baseline image. The method also includes comparing each of successive captured imaging lines with the baseline image of the respective lines. The method further includes determining one or more changes in discontinuities in the captured imaging lines due to interception caused by movement of the object based upon the comparison. The method also includes translating the changes in discontinuities to determine an occurrence of an event of interest and alerting an operator in case of occurrence of the event of interest.

### BACKGROUND

The invention relates generally to a system and method for detecting movement of objects, and more particularly, to monitoring of activities in a habitable structure.

Efficient monitoring of activities has become a common necessity in several healthcare and security applications. For example, in healthcare applications, many elderly people are at risk from a variety of hazards, such as falling, tripping, or illness. Health statistics and studies show that falling is a major problem among the elderly. The risk of falling increases with age, such that, studies suggest that about 32% of individuals above 65 years of age and 51% of individuals above 85 years of age fall at least once a year. In addition, many elderly people live alone. Therefore, the elderly are at additional risk that they may not be able to call for help or receive assistance in a timely manner after experiencing a fall or illness.

As a result, systems that enable a resident of a home to call for assistance from anywhere in a home have been developed. In addition, attempts have been made to develop systems that may be worn by a resident that will automatically send out a signal when the resident has fallen. One disadvantage of these devices is that they have to be worn by the person in order to work. These devices are useless if the person is not wearing them. In addition, a device that requires someone to activate it is useless if the person is unconscious. Thus, there is a risk that in an emergency situation, the resident may not receive the proper assistance in a timely manner.

Other systems rely on motion sensors to try to identify when a person has fallen. There may be extended periods where a resident is not moving for reasons other than the person having fallen or becoming incapacitated, such as watching television from a chair or sleeping in bed. Systems that rely on motion sensors require the person to be motionless for a considerable amount of time before the system is able to conclude that the resident has fallen or become incapacitated, as opposed to exhibiting normal inactive behavior.

Furthermore, the systems that detect falls are generally directed towards rapid motions towards the floor, or detecting an impact. However, incidents such as a senior citizen sliding slowly out of a bed or chair, or arrive on the floor and be in need of help without having experienced a rapid fall or string impact may not be accounted for by such detection systems. The existing detection systems are also commonly perceived as intruding privacy. For example, for falls that occur in a bedroom or a bath, video systems wherein an image is not transmitted out may be effective. However, a perception of privacy invasion may persist.

Therefore, an improved monitoring system that addresses one or more of the aforementioned issues is desirable.

### BRIEF DESCRIPTION

In accordance with an embodiment of the invention, a method for detecting location of an object is provided. The method includes projecting one or more imaging planes horizontally across a specified area near ground level and at none or least one pre-determined height from the ground level. The method also includes capturing respective imaging lines, via one or more imaging components, observed when objects intersect the projected imaging planes. The method further includes recording a standard shape of the respective imaging lines in absence of any persons or objects of interest within the specified area to establish a baseline image for each of the respective lines at a given time interval. The method also includes comparing each of successive captured imaging lines with the baseline of the respective lines. The method further includes determining one or more changes to the discontinuities in the baseline image in the captured imaging lines due to introduction of a new object or person into the viewing area. The method also includes translating the discontinuities to determine an occurrence of an event of interest and alerting an operator in case of such an event.

In accordance with another embodiment of the invention, a system for detecting the location of objects or persons in a space is provided. The system includes multiple radiation sources configured to project a plurality of imaging planes horizontally across a specified area at near ground level and at least one pre-determined height from the ground level. The system also includes one or more imaging components configured to capture respective imaging lines from the plurality of planes. The system further includes a processing subsystem configured to record a standard shape of the respective imaging lines in absence of any movement within the specified area. The processing subsystem also compares each of successive captured imaging lines with the standard shape of the respective lines. The processing subsystem further determines one or more changes to discontinuities in the captured imaging lines based upon the comparison. The processing subsystem also translates the changes to determine occurrence of an event of interest. The system also includes an alerting component configured to alert an operator in case of occurrence of the event of interest.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an exemplary system for monitoring an object in accordance with an embodiment of the invention.

FIG. 2 is a schematic illustration of exemplary transmission of data in the home monitoring system of FIG. 1 in accordance with another embodiment of the invention.

FIG. 3 is a flow chart representing steps in an exemplary method for detecting movement of an object in accordance with an embodiment of the invention.

FIG. 4 is a flow chart representation of an exemplary algorithm employed within the processing subsystem employed in FIG. 1.

### DETAILED DESCRIPTION

As discussed in detail below, embodiments of the invention include a system and method for detecting changes in location of objects and detecting events of interest. As used herein, the ‘event of interest’ refers to a fall of a person or detection of a large object near ground level. Particularly, the system and method may be implemented as a home monitoring system and method to detect when a resident in a home has fallen or is incapacitated. In another example, the home monitoring system and method may be implemented as a security system to detect any unusual activity within a habitable structure. The technique allows for remote monitoring of the habitable structure. Non-limiting examples of the habitable structure include old age homes, a residence, commercial buildings, manufacturing plants, wherein activity of people working alone and to enable assistance to be provided to the person in the event that the person becomes incapacitated.

The system and method employ an imaging system that captures imaging lines at near ground level and at one or more pre-determined heights above ground level within a specified area of interest. As used herein, the term ‘near ground level; refers to heights less than about 6 inches from ground level. The technique records a baseline image and compares successive images with the baseline image to detect changes in discontinuities in the imaging lines. It should be noted that discontinuities would arise due to introduction of any object within the specified area of interest and hence, may exist in the baseline image too, due to presence of objects such as, but not limited to, furniture. However, a fallen person, for example, may change the discontinuity of the imaging line only near ground level and not at any other pre-determined height in a characteristic manner. In another example, an object close to a detector (a component of the imaging system) may lead to a greater vertical disruption in the imaging line than an object that is at a further distance from the detector. Similarly, a horizontal discontinuity may be recorded. These changes in discontinuities are processed and analyzed further to detect a true event of interest, such as, but not limited to, that of a fallen person. In another embodiment, an approximate size of the object may be computed based upon the vertical and horizontal changes in discontinuities.

Furthermore, the technique implements non-visible radiation that detects captured imaged lines and does not detect objects located in field of view and thus, ensures protection of privacy within the habitual structure. However, it will be appreciated that the technique may also be implemented employing visible radiation in locations where privacy is not a concern.

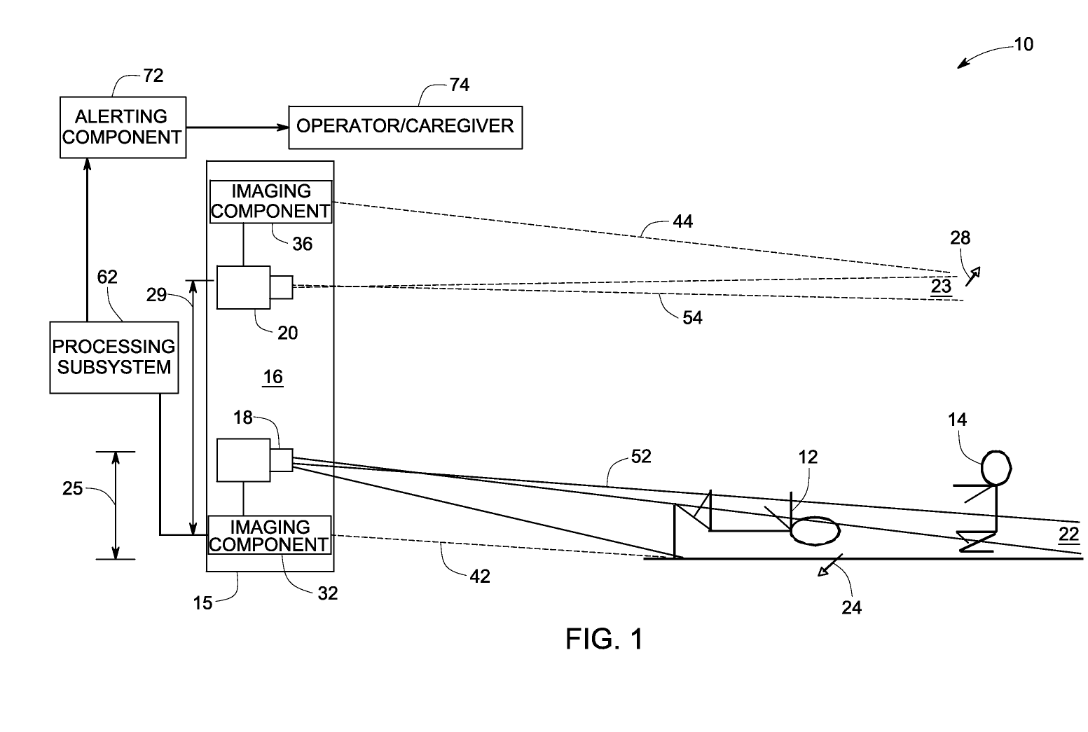

FIG. 1 is a schematic illustration of an exemplary system 10 for monitoring an object such as a fallen person 12, a kneeling person 14, and the like. The system 10 includes a frame 15 resting on a floor. The frame 15 includes a vertical riser 16 having one or more radiation sources 18, 20 that project multiple imaging planes such as 22, 23 across a specified area 24, 28 respectively in a living room or a bathroom, for example. In the illustrated embodiment, the radiation source 18 projects over area 24 near ground level up to about 4 inches above ground level, as referenced by numeral 25, and the radiation source 20 projects over area 28 from a height of between about 15 inches and about 36 inches above ground level, as referenced by numeral 29. One or more imaging components 32, 36 capture respective imaging lines 42 and 44 from the imaging planes 22, and 23. In a particular embodiment, the imaging components 32, 36 are infrared sensors. It should be noted that although 2 radiation sources and 2 imaging components are illustrated herein, any number of the radiation sources and imaging components may be employed. The radiation sources 18, 20 emit radiation beams 52 and 54 that are not visible to human eye. In one embodiment, the radiation sources 18, 20 are lasers or diodes. In an exemplary embodiment, the lasers or diodes are infrared lasers or infrared diodes. At an initial point of time, a processing subsystem 62 electrically coupled to the imaging components 32, 36 records a standard shape of the respective imaging lines 42 and 44 to establish a baseline image in absence of any person within the specified areas 24, 28. Such data is updated periodically at a pre-determined interval of time. The shape of the imaging lines successively captured at periodic intervals of time is compared with the baseline image of the respective lines to determine one or more changes in discontinuities. Within the processing subsystem 62 changes from the baseline are translated to determine occurrences of an event or events of interest such as, but not limited to, a fall of a person, or unusual movement. An alerting component 72 further sends an alert to an operator or caregiver 74 via at least one of a wired means, a wireless signal, audible alarm, text message or like in case of occurrence of the event of interest.

In one embodiment, the processing subsystem ensures that upper planes/lines such as 44 are not changed from the baseline for a reasonable period of time, and the discontinuity in ground level plane/line such as 42, has changed, in order to ascertain the occurrence of a fall and consequently, a true alarm is triggered. In the event that the discontinuity in upper planes/lines 44 has changed within the reasonable period of time, as well as the discontinuity in ground level plane/lines 42, the processing subsystem 62 translates the event as a person who had temporarily fallen, but recovered and is standing on his/her feet. The processing subsystem 62 computes the magnitude of difference in the discontinuities in the vertical and horizontal direction to determine size of the object. Such analysis ensures reduction of false alarms. Such events may also occur due to a person briefly bending down or laying down or a pet animal jumping.

In one embodiment, the radiation sources 18, 20 may be duty cycled to save power or increase laser safety. For example, all events of interest include change in discontinuity in imaging line at or near ground level. In such a scenario, one or more additional radiation sources and imaging components may be turned off until a change in discontinuity is detected in the imaging line near ground level. In another embodiment, radiation sources may emit radiation at periodic intervals of about 30 ms or greater, for example for laser safety and power efficiency.

In yet another embodiment, the system may further detect if the field of view or specified area of interest is blocked and issue a maintenance alarm. Blocking may arise due to the imaging component unable to detect an imaging line/s or due to blocking sunlight. In another embodiment, the system 10 may optionally include an additional proximity sensor coupled to the radiation sources 18, 20 that shuts down the sources 18, 20, in an event that a person is within an undesirable distance that may damage the eye.

It should be noted that embodiments of the invention are not limited to any particular processor for performing the processing tasks of the invention. The term “processing subsystem,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processing subsystem is equipped with a combination of hardware and software for performing the tasks of the invention, as will be understood by those skilled in the art.

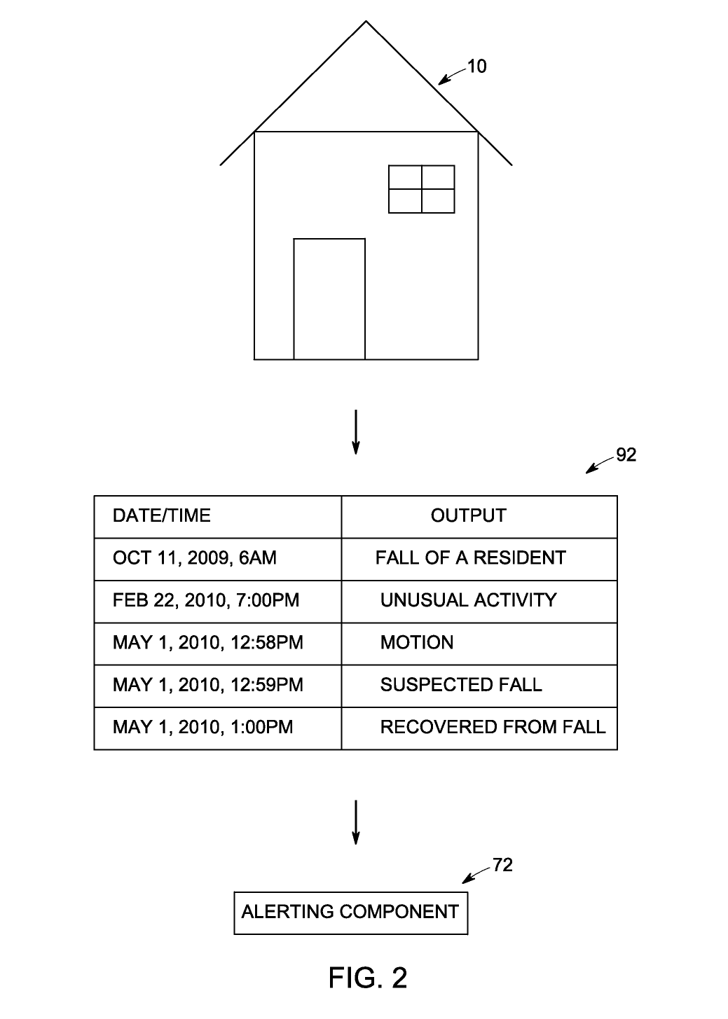

FIG. 2 is a schematic illustration of exemplary transmission of data 92 in the home monitoring system 10 of FIG. 1. As described above, the data 92 is collected via the imaging components 32, 36 and processed within the processing subsystem 62. In the illustrated embodiment, the data 92 includes temporal information 76 such as the date and time at which information is recorded, and location and type of event. For example, as illustrated, at 6:00 AM on Oct. 11, 2009, the processing subsystem 62 concludes that the resident had a fall. This implies that discontinuity in the imaging line 42 (FIG. 1) was changed from the baseline, while discontinuity in the imaging line 44(FIG. 1) was unchanged over a pre-determined period of time. In another example, the data suggests that there was unusual/suspicious activity at 7:00 PM, Feb. 2, 2008, due to movement that was detected at a secure location. In yet another example, the processing subsystem 62 concludes a temporary fall of resident fell/similar event such as, but not limited to, bending of the resident, at 1 PM, on May 1, 2009. This was based on the fact that after discontinuity in both the imaging lines 42 and 44 near ground level and the height above ground level respectively, were changed from baseline at 12:58 PM, only the discontinuity in the imaging line 42 was changed at 12:59 PM, and soon after, at 1 PM, the discontinuities in both the imaging lines 42 and 44 were changed. The time difference between changes in discontinuities in the imaging lines 42, 44 is utilized to establish if the resident is experiencing a period of unusual inactivity, such as falling down and being unable to get up or being sick in bed.

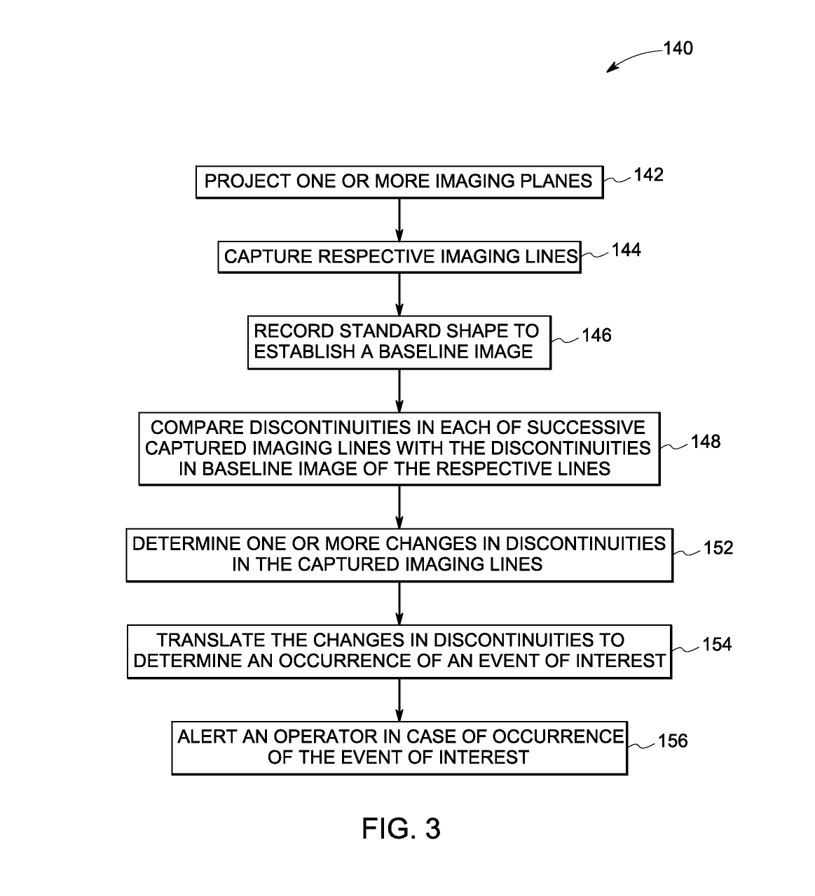

FIG. 3 is a flow chart representing steps in an exemplary method 140 for detecting movement of an object in accordance with an embodiment of the invention. The method 140 includes projecting multiple imaging planes horizontally across a specified area at a ground level and at least one pre-determined height from the ground level in step 142. Respective imaging lines from the multiple planes via one or more imaging components are captured in step 144. A standard shape of the respective imaging lines in absence of any movement within the specified area is recorded in step 146. Each of the successive captured imaging lines are compared with the standard shape of the respective lines in step 148. One or more changes in discontinuities of the captured imaging lines due to interception caused by the object are determined in step 152 based upon the comparison. The discontinuities are further translated in step 154 to determine an occurrence of an event of interest. In a particular embodiment, the translation or analysis of the discontinuities includes determining if the imaging lines captured near ground level and the at least one pre-determined height are discontinuous. In another embodiment, a fall of a human being or an animal is determined as an event of interest. In yet another embodiment, a burglary event is determined as an event of interest. In such a burglary event, it is determined if at least one of the imaging lines captured near ground level and at least one pre-determined height at a secure location are discontinuous. In another embodiment, the translation or analysis of the discontinuities includes translating a change in location of the captured imaging lines relative to the baseline image. In another embodiment, a bend in the captured imaging lines relative to the baseline image is translated. In yet another embodiment, a break in the captured imaging lines relative to the baseline image is translated. In another embodiment, an absence of the captured imaging lines relative to the baseline image is translated.

Furthermore, an operator is alerted in step 158 in case of occurrence of the event of interest. In one embodiment, the operator or a caregiver is alerted via at least one of a wireless means, an audible means or a text message. In another embodiment, an alert for a fall of a person/resident is triggered only in the event that both of the imaging lines captured near ground level and the at least one pre-determined height are discontinuous.

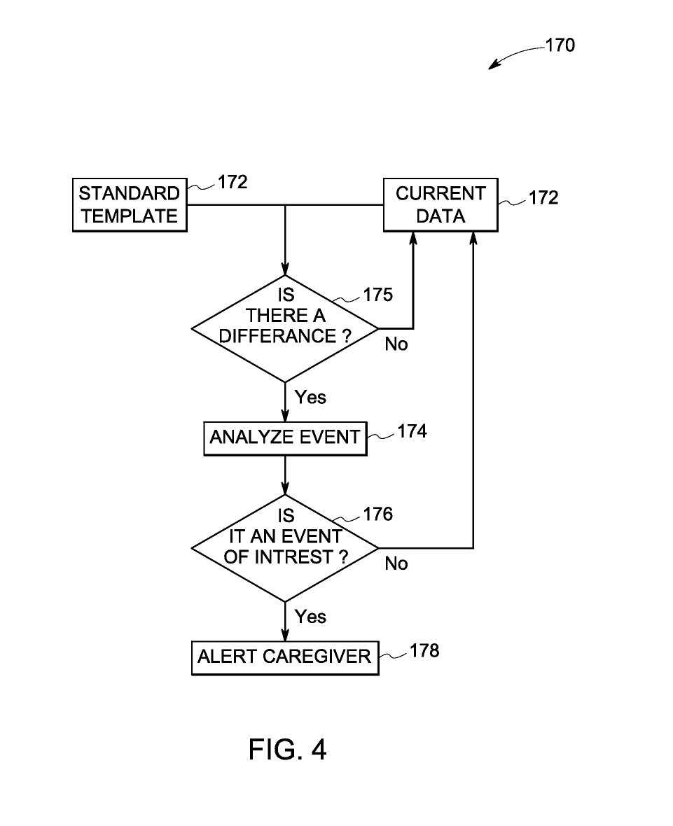

As noted above, the standard baseline image is recorded to learn or analyze the resident's activity over a period of time. FIG. 4 is a flow chart representation of an exemplary algorithm 170 employed within the processing subsystem 62 (FIG. 1). The standard baseline image 172 recorded and a current data 174 that is recorded via the imaging components 32, 36 (FIG. 1) are compared, as referenced by numeral 175, to check for any difference in discontinuities between the standard shape 172 and the current recorded shape 174. In case of a difference, the data is analyzed 176 to determine if the event is an event of interest. In case of such an event of interest, an operator/caregiver is alerted 178.

One skilled in the art will appreciate that the system also may be utilized to determine and report unusual activity of a resident. For example, the system may be configured to detect a case when the resident exhibits activity when the resident would not normally be expected to be active, such as activity at night when the resident would be expected to be sleeping. Furthermore, the system may be configured to detect cases when the resident is exhibiting activity at a location where it is not normal for the resident to exhibit activity. Similarly, the system may be configured to detect sleepwalking.

The various embodiments of the system and method for detecting movement of objects described above thus provide a way to achieve a convenient and efficient means for monitoring activity for healthcare and security applications. The technique also enables remote monitoring and significantly reduces the risk of false alarms. Further, the system and technique allows for safer and cost effective monitoring means.

Advantageously, the system may be employed for various applications. For example, the system may be installed to monitor a stairway and detect when a person is on the stairway or has stopped in a stairway. In another embodiment, the system may be installed near a pool/tub allowing detection of a person entering the pool/tub. In yet another embodiment, the system may be installed in a sporting field to detect a person practicing alone in the field and is injured. In another embodiment, the system may be installed in areas to detect any prohibited activities such as, for example, skateboarding. The system also allows for wide area detection of activities where privacy is not a high concern.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for detecting changes in the locations of persons and objects, comprising:
projecting a plurality of imaging planes across a specified area near ground level and at none or at least one pre-determined height from the ground level;
capturing respective imaging lines from the plurality of planes via one or more imaging components, observed when the objects or persons intersect the projected imaging planes;
recording a standard shape of the respective imaging lines in absence of any person or object within the specified area to establish a baseline image;
comparing discontinuities in each of successive captured imaging lines with the discontinuities in baseline image of the respective lines;
determining one or more changes in discontinuities in the captured imaging lines due to interception caused by movement of the object based upon the comparison;
translating the changes in discontinuities to determine an occurrence of an event of interest; and
alerting an operator in case of occurrence of the event of interest.

2. The method of claim 1, wherein said alerting comprises alerting via at least one of a wireless means, an audible means, a text message or a wired means.

3. The method of claim 1, wherein said translating comprises determining changes in vertical discontinuity and horizontal discontinuity of the imaging lines captured near ground level and the at least one pre-determined height.

4. The method of claim 1, wherein said determining an event of interest comprises detecting a fallen human being.

5. The method of claim 4, wherein said alerting comprises alerting of the fall only when changes in discontinuities are observed in the imaging lines captured near ground level alone and not at the imaging lines captured at the one or more pre-determined heights.

6. The method of claim 1, wherein said determining an event of interest comprises determining a burglary event.

7. The method of claim 6, wherein said alerting comprises alerting of the burglary event when at least one of the imaging lines captured near ground level and the at least one pre-determined height are discontinuous.

8. The method of claim 1, wherein said translating the changes in discontinuities comprises translating a change in location of the captured imaging lines relative to the baseline image.

9. The method of claim 1, wherein said translating the changes in discontinuities comprises translating a bend in the captured imaging lines relative to the baseline image.

10. The method of claim 1, wherein said translating the changes in discontinuities comprises translating a break in the captured imaging lines relative to the baseline image.

11. The method of claim 1, wherein said changes in discontinuities comprises translating an absence of the captured imaging lines relative to the baseline image.

12. A system for detecting movement of an object, comprising:
a plurality of radiation sources configured to project a plurality of imaging planes across a specified area near a ground level and at none or at least one pre-determined height from the ground level;
one or more imaging components configured to capturing respective imaging lines from the plurality of planes;
a processing subsystem configured to:
record a standard shape of the respective imaging lines in absence of any object within the specified area to establish a baseline image;
compare each of successive captured imaging lines with the standard shape of the respective lines;
determine one or more changes in discontinuities in the captured imaging lines based upon the comparison; and
translate the changes in discontinuities to determine occurrence of an event of interest; and
an alerting component configured to alert an operator in case of occurrence of the event of interest.

13. The system of claim 12, wherein said alerting component comprises a wireless component.

14. The system of claim 12, wherein said radiation sources comprise lasers or diodes.

15. The system of claim 14, wherein said lasers comprises infrared lasers.

16. The system of claim 14, wherein said diodes comprise infrared diodes.

17. The system of claim 12, wherein said event of interest comprises a fall of a human being or an animal.

18. The system of claim 12, further comprising:
a frame configured to rest on a floor, the frame having a vertical riser on which a first of the plurality of radiation sources is located between about 1 and about 4 inches above the ground level and on which a second of the plurality of radiation sources is located between about 15 and about 36 inches above the ground level, and wherein the one or more imaging components are disposed on the vertical riser.

19. The system of claim 12, wherein said event of interest comprises a burglary.

20. The system of claim 12, wherein said specified area comprises a living room or a bathroom.
